(19) United States
(12) Patent Application Publication
(10) Pub. No.: US 2007/0067425 A1
(43) Pub. Date: Mar. 22, 2007

(54) Method to display transaction performance data in real-time handling context

(76) Inventor: Howard Milton McKinney, Austin, TX (US)

Correspondence Address: IBM CORPORATION (RHF), C/O ROBERT H. FRANTZ, P. O. BOX 23324, OKLAHOMA CITY, OK, 73123, US

(21) Appl. No.: 11/230,341

(22) Filed: Sep. 20, 2005

(51) Int. Cl. G06F 15/173

(52) U.S. Cl. 709/223

(57) ABSTRACT

A system and method for providing a performance-based choreographer-architecture style visualization of an application program, in which an original electronic workflow representation of the application is modifying to incorporate certain run-time performance indicators as collected from a performance monitoring system. This provides a diagram, typically only available during the design phase, annotated with performance data typically only available in diagrams with other perspectives than the design perspective. The invention is especially useful for annotation workflow diagrams produced by choreographer architecture design systems.

### INCORPORATION BY REFERENCE

The following documents, all of which are publicly available at the time of filing this application on:

http://publib<dot>boulder<dot>ibm<dot>com/infocenter/tiv3help

where <dot> indicates a “.” character, and for which a copy is supplied herewith in an Information Disclosure Statement:

(a) “Introduction to IBM Tivoli Monitoring for Transaction Performance” by International Business Machines Tivoli Software, 1 page;
(b) “IBM Tivoli Monitoring for Transaction Performance Application Response Measurement (ARM) Instrumentation Guide” by International Business Machines Tivoli Software, 23 pages;
(c) “Sample Configuration” by International Business Machines Tivoli Software, 2 pages;
(d) “Investigating the structure and performance of transactions through topology” by International Business Machines Tivoli Software, 1 pages; and
(e) “Navigating and understanding the topology report” by International Business Machines Tivoli Software. 21 pages.

### BACKGROUND OF THE INVENTION

1. Field of the Invention

This invention relates to a method to display transaction performance information relative to a workflow diagram for a transaction.

2. Background of the Invention

In the early 1980's, most businesses ran their applications on mainframe computers—large computers that were accessed via a “dumb” terminal. As business needs changed and technology improved, technical architecture shifted toward a distributed network model.

Today, the common programming model for distributed applications is the client-server model. The “client”, also known as the user, generally initiates an execution on a personal computer or workstation. A “host” or “server” computer executes the functions for the client, and processes and manipulates data depending on the types of applications residing on the server itself. Because business practices have altered with the use of Internet and distributed computing, an increase in transactions are being performed, whether directly with the customer or within a company itself.

Therefore, companies are monitoring their transaction handling application programs running at the host and observing its inbound and outbound responses. Traditionally, monitoring the performance and availability of distributed applications has not been easy, nor has it provided adequate information to developers. Therefore, the use of Application Response Measurement (“ARM”) Application Program Interface (“API”) has become critical in application monitoring. Products such as International Business Machines Tivoli Monitor for Transaction Performance (“ITMTP”) use the ARM API and provide a suite of capabilities for the analyst to determine actual performance of a transaction handling process.

By using ARM API, sections of an application program can be instrumented at specific points in their methods or processes to generate information to the performance monitoring system. This information is then collected during runtime by the performance monitoring system for analysis. For example, each method, Java bean, etc., can be instrumented with ARM API calls at their entrances, their exits, and key points within their processes to allow the collected data to indicate when each module is called, how long it takes to complete, and key points within their processes.

This allows the applications to be monitored by measurement agent programs, while providing flexibility for users of the application to choose a measurement agent that best meets their needs, without needing to change the application itself. By instrumenting the application through adding ARM API calls, transaction handling performance data can be collected.

“Instrumentation” (i.e. added of ARM API calls) of the application program can be achieved by adding the ARM API calls directly to the source code of the transaction handling application components during development. Alternatively, using methods such as byte-code insertion, an existing executable application program component can be instrumented by added the ARM API calls after development. In some situations, a combination of both methods may be employed to instrument an application program and its components for performance monitoring.

FIG. 4 shows an example of how ARM API works with enterprise management applications (40). The client application (41) can access its related applications on the business application servers (43) via the network (42) such as local area network (“LAN”), wide area network (“WAN”), or virtual private network (“VPN”). An ARM API (44a) along with its associated measurement agent (45a) monitors the details on the transactions, and collects that information and sends it to the enterprise management solutions (46).

Respectively, on the client side, an ARM API (44b) and its measurement agent (45b) keeps track of its activities and sends the data to the enterprise management solutions as well. The data generated by the ARM API are designed to give the application or system managers information to understand how the environment is performing and whether all services are available.

The current trend in Java 2 Enterprise Edition platform (“J2EE”) application management is to monitor and manage the e-business “transactions” rather than the actual application or the resources used by the application such as memory and disk storage. This trend indicates the desire of customers to focus on user productivity and focuses more on managing the business instead of the device.

Therefore, third party monitoring applications such as ITMTP (47) can be used to capture detailed performance data for e-business transactions, monitoring every step of customer transactions as it passes through the various applications, systems, and hosts. Once ITMTP gathers the information, it can proactively recognize, isolate and repair problems early. In addition, transaction data (48) are reported to generate topology diagrams where the application's method calls are depicted in a graphical display referred to as a “topological performance display”.

A topological performance display graphically illustrates the sequence of method calls as they were performed, along with some information captured by the performance monitoring system, such as time of invocation, completion time, etc. This display shows the relationship over time during execution of the modules, components, and objects, but not the functional or logical relationship of the modules, components, and objects.

Another emerging industry trend that is based on the desire to boost productivity is the implementation of workflow-based applications, where the process model is described at a much higher level of abstraction from the detailed code implementation level. Using such a design and development methodology can reduce the time and cost of building new or changing existing applications.

When a transaction handling process is designed, it is usually created using a development environment where the workflow may be built graphically, using a very high level, behavior-based visualization approach. For example, in the context of a J2EE application program, a transaction handling process is viewed or visualized by a designer as a choreographed set of activities that represents a real-world business operation. The processes behavior(s) are often described in languages such as Web Services Flow Language (“WSFL”), Flow Definition Markup Language (“FDML”) or Business Process Execution Language (“BPEL”). We will refer collectively to these types of high-level, graphical-based and behavior-related design tools and methodologies as “choreographer architecture” tools and methodologies in the present disclosure.

Unlike a topological performance display from a performance monitoring system, a graphical workflow diagram shows the functional or logical relationship of the modules, components, and objects from a higher level perspective of behaviors, during development and before actually running an application and its associated components.

WSFL is an XML-like language for the description of Web Services (“WS”) compositions. There are generally two types of WS compositions: (a) flow models, and (b) global models. Flow models specify the appropriate usage pattern of a collection of WS which result in a description of a business process. Global models, on the other hand, depict the interaction pattern of a collection of WS with each other.

FDML is an IBM proprietary, publicly known format used to describe processes in WebSphere Application Server (“WAS”) enterprise. In FDML, a process is composed of links, variables, and activities. Links determine the sequences in which the activities will be executed, variables denote the data that is being processed, and activities represent either service or non-service operations within a process. FDML is an XML language which is based on the flow related aspect of WSFL. Tutorials and specifications regarding FDML are readily available to the public via IBM and IBM's web site.

BPEL is another methodology that also specifies, according to behavior, a process by formalizing what pieces of information comprise a transaction order, what exceptions may have to be handled, and what methods or behaviors are to be performed for each transaction type.

In recent years, programmers from BEA Systems, IBM, and Microsoft have modified BPEL using a combination of WS which allows this XML-based language to be used across multiple organizations as well as enable task-sharing for a distributed computing environment. BPEL is now sometimes identified as BPELWS or BPEL4WS.

Turning to FIG. 5, a sample of a typical process choreographer programming model is shown to describe BPEL (50). A client application or Graphical User Interface (“GUI”) (51) is used to access via the different types of interfaces (52) such as Message Driven Bean (“MDB”) Facade, Enterprise Java Bean (“EJB”) Facade, Simple Object Access Protocol (“SOAP”) WS, or API. The process model (53) is a template from which each process is instantiated and an instance of the process model is created. The graphical depiction of a process is a directed graph constructed with related activities and associated control connectors.

There are various types of activities which are used to address different types of tasks that needs to be performed. In this diagram, the service activities (54) such as XML Schema Definition (“xsd”) Types files and WSDL are used to invoke certain operations. Invoked activities can be performed synchronously or asynchronously and processed via the Transaction Handling/Business Process Engine (“BPE”) (55). The results pass through its platform such as J2EE (56) and any associated messages, data, or information collected will be transfer to the appropriate middleware (57) such as database, message system, or even a legacy software for record storage. Subsequently, the data flow or information passes back to the client application (58) with its related files in xml format for further use.

By using any of these languages and methodologies to describe a transaction handling process, a workflow is built graphically during development environment.

Although the efficiency of creating new transaction handling processes using a behavioral description methodology and graphic workflows can be achieved using any of the previously mentioned languages, and the post-development run-time analysis of the actual transaction handling performance of the process(es) can be readily analyzed using topological diagrams generated by performance monitoring systems, there is currently no efficient way to relate the actual performance data to the development-oriented workflow diagrams. In other words, the information gleaned by a user from viewing a functional or behavioral design diagram such as a workflow during development, and the information comprehended by a user from viewing a performance monitor topological diagram is not available, and cannot be readily generated, by available tools and technologies.

Therefore, there exists a need in the art for a system and method to display transaction handling performance data in the graphical context of a behavioral workflow diagram.

### SUMMARY OF THE INVENTION

The present invention provides an intuitive display of a workflow of a business transaction hander in terms of its original design annotated with its current status and performance characteristics. Run-time performance data collected from an instrumented applications is used in conjunction with an associated process model language, preferrably received from a choreographer architecture design tool. The invention generates an annotated workflow diagram from the original workflow diagram created during design, annotated by ARM-collected performance data, and graphically displays the annotated workflow diagram to show current stage of workflow along with its related transaction performance information.

According to one aspect of an available embodiment, an extensible markup language (“XML”) workflow diagram is annotated and produced, optionally using performance data collected from an application response measurement (“ARM”) system. The annotated workflow process diagram can be displayed to the user, printed to a report, or both.

According to other aspects of the invention, annotations can include, but are not limited to, a time value indicating when each software method was called, a time value indicating when the method was completed, a time value indicating the duration of executing of the method, an indication of how many times a method was called, an indication of which methods have not been executed at least one time, and an indication of the execution status of the method.

### BRIEF DESCRIPTION OF THE DRAWINGS

The following detailed description when taken in conjunction with the figures presented herein provide a complete disclosure of the invention.

FIG. 1 illustrates an arrangement of cooperating systems according to the present invention.

FIGS. 2a and 2b show a generalized computing platform architecture, and a generalized organization of software and firmware of such a computing platform architecture.

FIG. 3 illustrates the annotated workflow output diagram produced by the present invention, including special annotations regarding actual performance data collected from a performance monitoring system such as ARM.

FIG. 4 shows how the measurement agents that implement the ARM API, enterprise management applications, and business applications that call the ARM API, work together to provide a robust way to monitor application response.

FIG. 5 describes, in a general manner, one available design methodology (e.g. BPEL) from which a graphical workflow can be obtained for annotation.

FIG. 6 describes a logical process according to the present invention.

FIG. 7 shows an example of a typical workflow diagram for an online purchase transaction handler produced by a design environment such as BPEL.

### DESCRIPTION OF THE INVENTION

The present invention provides a more intuitive display of the design of a choreographer-architecture created transaction handling process in terms of its original design model, enhanced to include performance information and data. The original design model is preferably produced using one of several available design systems and methodologies known as “choreographer architecture” tools which model computer processes behaviorally, such as but not limited to Web Services Flow Language (“WSFL”), Flow Definition Markup Language (“FDML”) or Business Process Execution Language (“BPEL”). In the present disclosure, we will refer collectively to these types of high-level, graphical-based and behavior-related design tools and methodologies as “choreographer architecture” tools and methodologies in the present disclosure.

To accomplish this objective, the invention maps ARM transaction data to the process model language such as WSFL, BPEL, or FDML in which the application was created, and then generates an annotated workflow diagram from the performance data which has been collected from the properly instrumented application. This allows the workflow diagram to be displayed incorporating the actual performance data, thereby allowing run-time or deployment understanding and analysis of the application, but in terms of the original design.

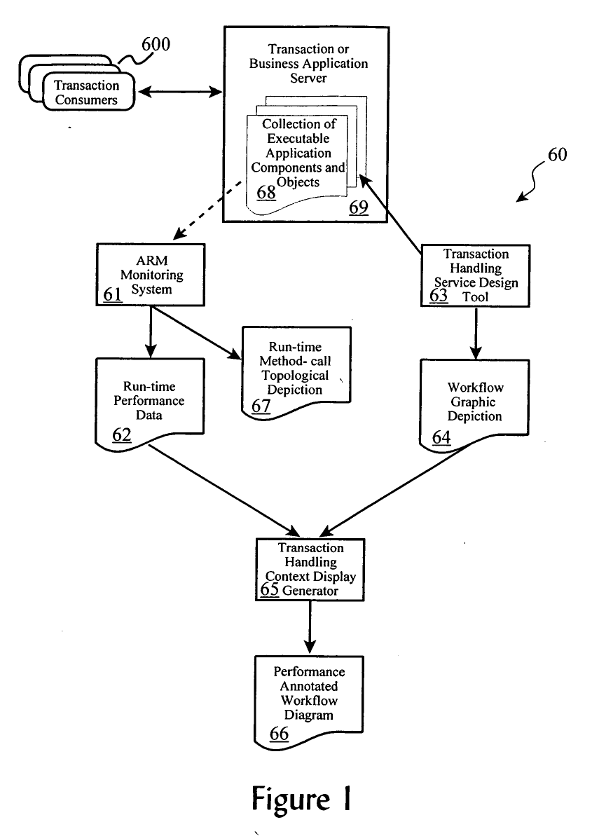

Turning to FIG. 1, an arrangement of cooperating systems according to the present invention is shown (60). The application program, its objects and components (68) are created using a choreographer architecture design tool (63), during which a computer readable workflow graphic depiction (64) of the components and objects relationships relative to their design model is produced. Many of the aforementioned choreographer architecture design tools will produce such a workflow diagram in XML, for example. This diagram provides the visualization to the designer of the design model of the application in terms of the design, not the actual runtime operation.

Next, the components (68) are installed on one or more server platforms (69), such as a WAS server. At this point, the application program, components, and objects should be properly instrumented for ARM data collection, either by having added ARM correllators during design, or by inserting ARM API correllators into the executable code prior to execution. Then, the application program (68) is executed by the server (69) and exercised by one or more transaction consumers (600).

By utilizing the ARM Monitoring System (61), performance data of handled transactions are captured via its API correllators from the components and objects of the application program (68). This collected performance data (62) is received by the transaction handling context display generator (65) for use in generating a performance annotated workflow diagram (66).

The transaction handling context display generator (65) uses the information generated from each respective sources, such as the ARM Monitor System and the BPEL Process Development System, to create the annotated business process flow output (66). This performance annotated workflow diagram shows the workflow perspective further annotated by certain actual performance information, optionally including whether or not each object within the workflow is executed.

According to one aspect of present invention, preexisting performance data collected by the application instrumentation such as ARM is mapped to the process language used to generate the business program from which it was capture, such as a BPEL design. Using this general methodology, the invention creates the annotated workflow diagram showing its current status and actual state of the flow.

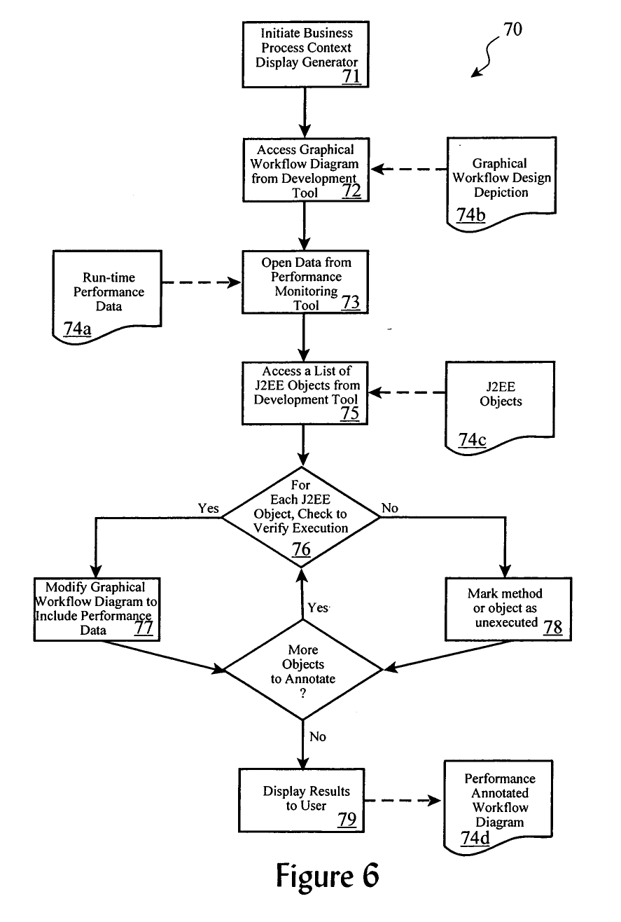

Turning to FIG. 6, the diagram describes a logical process (70) according to the present invention. The transaction handling context display generator (65) is invoked (71), and it requests (72) access to a corresponding workflow diagram (74b) and it accesses the respective program objects (74c). It also opens data (73) from the performance analysis tools which have gathered performance information, such as ARM data (74a).

For each program object, such as each J2EE object, the system verifies (76) whether or not it has been executed or not. If execution has occurred, it modifies the corresponding graphical object in the workflow diagram (74b) to denote the executed/not executed status. Such notation can be in any form, but not limited to producing a shaded box, colored shapes, special marking, hash marks, highlight, and graying-out of the graphical object. If a program object has not been executed, it is identified to note that the object has not been processed within a workflow (78).

Once the system has checked and verified that all related objects in the workflow have been either executed or not, the annotated workflow diagram (74d) is made available for display to the user/designer (79), such as showing it in a GUI, printing it to paper, or sending it via an electronic message.

According to another aspect of the present invention, the workflow diagram is further annotated to show performance information such as, but not limited to, the elapsed time of execution for each program object, the time an object was called or instantiated, the time the object's processing ended, the number of times an object has been executed, etc. This performance annotated workflow diagram enables a new way to analyze application program performance by combining the display or visualization of actual performance data in the context of the choreographer architecture workflow diagram.

Now, to illustrate the invention in a lifelike scenario, we present a hypothetical application of the invention to a online purchase process. It will be understood by those skilled in the art, however, that this is just an illustrative example, and that the present invention is not limited to use or application of such financial types of transactions.

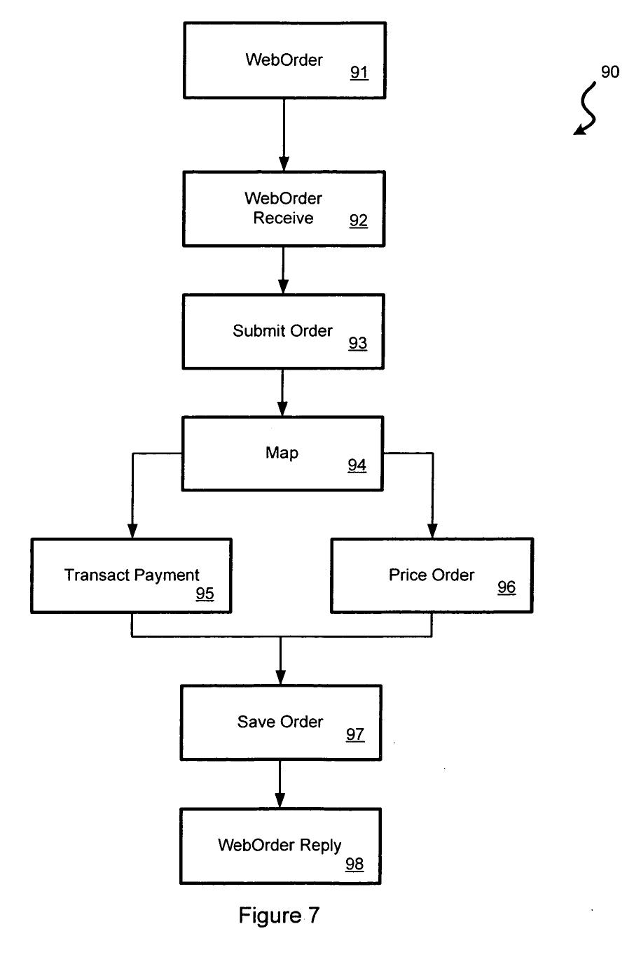

Turning to FIG. 7, an example of a typical workflow diagram output directly from a design environment, such as BPEL, for an online transaction handling process, is shown. This example illustrates a predefined workflow that allows customers to place orders online (90). A customer initiates a new WebOrder (91), and the WebOrder is received (92) by the system. The WebOrder submits (93) into the system for further appropriate processing. If the customer wants to place the order, the payment information is collected to transact the payment (95) process. When the payment process is completed, then the order is saved (97) in the customer order history file and a WebOrder Reply (98) such as a confirmation information is shown.

On the other hand, if the customer asks for a pricing of a tentative order, the system will calculate and generate a Price Order (96). Then, this order information is stored (97) and a WebOrder Reply (98) is given.

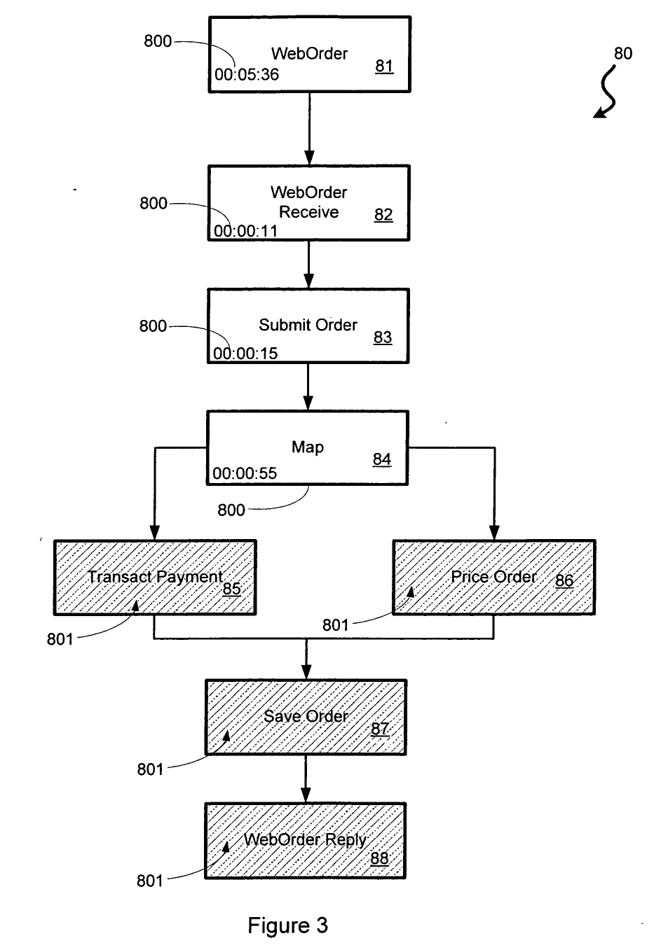

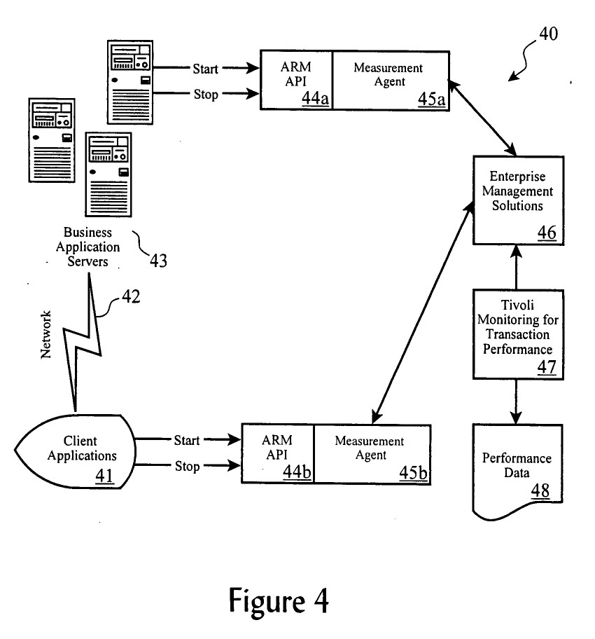

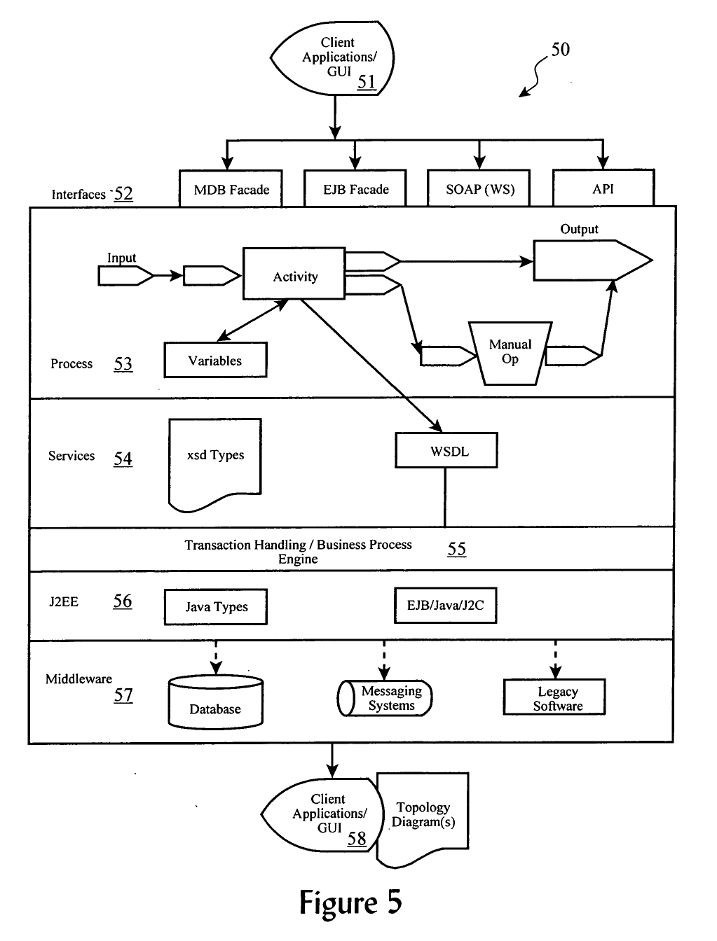

Using the present invention, a greatly enhanced visualization (80) of the same information shown in FIG. 7 is provided by the invention, enhanced by annotations (800, 801) regarding collected performance data, as shown in FIG. 3. Using the two types of annotations shown in this example, performance data such as times of execution (800) can be displayed simultaneously with the status of the process (801), such as shading or coloring of modules currently executing, previously executed, unexecuted.

This seemingly uncomplicated view of the workflow diagram is quite powerful in reality. This information allows administrators to quickly and intuitively analyze whether or not the system itself is performing at its set optimal level based on the time it completes a specified process object. The output is more intuitive, and for the first time, provides a display of a processes topology in terms of its original design simultaneously with its performance data, its current status, or both.

Suitable Computing Platform

The invention is preferably realized as a feature or addition to the software already found present on well-known computing platforms such as personal computers, web servers, and web browsers. These common computing platforms can include personal computers as well as portable computing platforms, such as personal digital assistants (“PDA”), web-enabled wireless telephones, and other types of personal information management (“PIM”) devices.

Therefore, it is useful to review a generalized architecture of a computing platform which may span the range of implementation, from a high-end web or enterprise server platform, to a personal computer, to a portable PDA or web-enabled wireless phone.

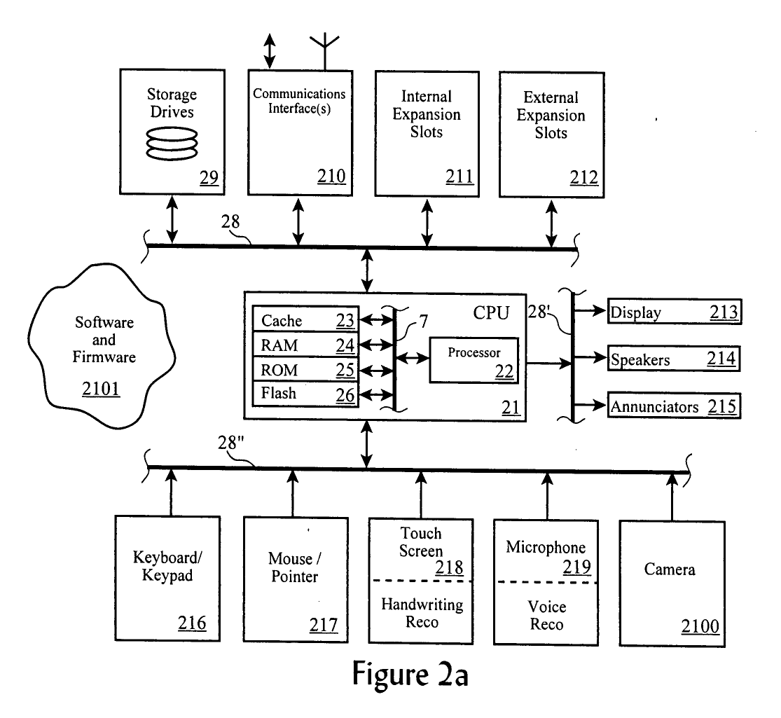

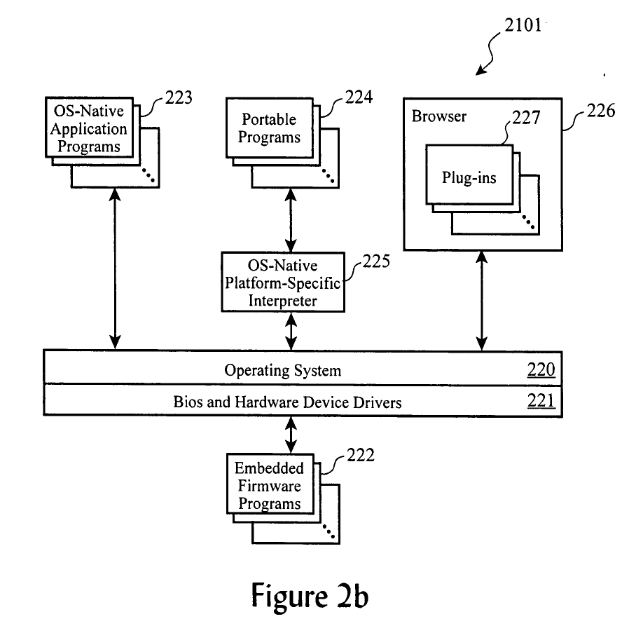

Turning to FIG. 2a, a generalized architecture is presented including a central processing unit (21) (“CPU”), which is typically comprised of a microprocessor (22) associated with random access memory (“RAM”) (24) and read-only memory (“ROM”) (25). Often, the CPU (21) is also provided with cache memory (23) and programmable FlashROM (26). The interface (27) between the microprocessor (22) and the various types of CPU memory is often referred to as a “local bus”, but also may be a more generic or industry standard bus.

Many computing platforms are also provided with one or more storage drives (29), such as a hard-disk drives (“HDD”), floppy disk drives, compact disc drives (CD, CD-R, CD-RW, DVD, DVD-R, etc.), and proprietary disk and tape drives (e.g., Iomega Zip [TM] and Jaz [TM], Addonics SuperDisk [TM], etc.). Additionally, some storage drives may be accessible over a computer network.

Many computing platforms are provided with one or more communication interfaces (210), according to the function intended of the computing platform. For example, a personal computer is often provided with a high speed serial port (RS-232, RS-422, etc.), an enhanced parallel port (“EPP”), and one or more universal serial bus (“USB”) ports. The computing platform may also be provided with a local area network (“LAN”) interface, such as an Ethernet card, and other high-speed interfaces such as the High Performance Serial Bus IEEE-1394.

Computing platforms such as wireless telephones and wireless networked PDA's may also be provided with a radio frequency (“RF”) interface with antenna, as well. In some cases, the computing platform may be provided with an infrared data arrangement (“IrDA”) interface, too.

Computing platforms are often equipped with one or more internal expansion slots (211), such as Industry Standard Architecture (“ISA”), Enhanced Industry Standard Architecture (“EISA”), Peripheral Component Interconnect (“PCI”), or proprietary interface slots for the addition of other hardware, such as sound cards, memory boards, and graphics accelerators.

Additionally, many units, such as laptop computers and PDA's, are provided with one or more external expansion slots (212) allowing the user the ability to easily install and remove hardware expansion devices, such as PCMCIA cards, SmartMedia cards, and various proprietary modules such as removable hard drives, CD drives, and floppy drives.

Often, the storage drives (29), communication interfaces (210), internal expansion slots (211) and external expansion slots (212) are interconnected with the CPU (21) via a standard or industry open bus architecture (28), such as ISA, EISA, or PCI. In many cases, the bus (28) may be of a proprietary design.

A computing platform is usually provided with one or more user input devices, such as a keyboard or a keypad (216), and mouse or pointer device (217), and/or a touch-screen display (218). In the case of a personal computer, a full size keyboard is often provided along with a mouse or pointer device, such as a track ball or TrackPoint [TM]. In the case of a web-enabled wireless telephone, a simple keypad may be provided with one or more function-specific keys. In the case of a PDA, a touch-screen (218) is usually provided, often with handwriting recognition capabilities.

Additionally, a microphone (219), such as the microphone of a web-enabled wireless telephone or the microphone of a personal computer, is supplied with the computing platform. This microphone may be used for simply reporting audio and voice signals, and it may also be used for entering user choices, such as voice navigation of web sites or auto-dialing telephone numbers, using voice recognition capabilities.

Many computing platforms are also equipped with a camera device (2100), such as a still digital camera or full motion video digital camera.

One or more user output devices, such as a display (213), are also provided with most computing platforms. The display (213) may take many forms, including a Cathode Ray Tube (“CRT”), a Thin Flat Transistor (“TFT”) array, or a simple set of light emitting diodes (“LED”) or liquid crystal display (“LCD”) indicators.

One or more speakers (214) and/or annunciators (215) are often associated with computing platforms, too. The speakers (214) may be used to reproduce audio and music, such as the speaker of a wireless telephone or the speakers of a personal computer. Annunciators (215) may take the form of simple beep emitters or buzzers, commonly found on certain devices such as PDAs and PIMs.

These user input and output devices may be directly interconnected (28′, 28″) to the CPU (21) via a proprietary bus structure and/or interfaces, or they may be interconnected through one or more industry open buses such as ISA, EISA, PCI, etc.

The computing platform is also provided with one or more software and firmware (2101) programs to implement the desired functionality of the computing platforms.

Turning to now FIG. 2b, more detail is given of a generalized organization of software and firmware (2101) on this range of computing platforms. One or more operating system (“OS”) native application programs (223) may be provided on the computing platform, such as word processors, spreadsheets, contact management utilities, address book, calendar, email client, presentation, financial and bookkeeping programs.

Additionally, one or more “portable” or device-independent programs (224) may be provided, which must be interpreted by an OS-native platform-specific interpreter (225), such as Java [TM] scripts and programs.

Often, computing platforms are also provided with a form of web browser or micro-browser (226), which may also include one or more extensions to the browser such as browser plug-ins (227).

The computing device is often provided with an operating system (220), such as Microsoft Windows [TM], UNIX, IBM OS/2 [TM], IBM AIX [TM], open source LINUX, Apple's MAC OS [TM], or other platform specific operating systems. Smaller devices such as PDA's and wireless telephones may be equipped with other forms of operating systems such as real-time operating systems (“RTOS”) or Palm Computing's PalmOS [TM].

A set of basic input and output functions (“BIOS”) and hardware device drivers (221) are often provided to allow the operating system (220) and programs to interface to and control the specific hardware functions provided with the computing platform.

Additionally, one or more embedded firmware programs (222) are commonly provided with many computing platforms, which are executed by onboard or “embedded” microprocessors as part of the peripheral device, such as a micro controller or a hard drive, a communication processor, network interface card, or sound or graphics card.

As such, FIGS. 2a and 2b describe in a general sense the various hardware components, software and firmware programs of a wide variety of computing platforms, including but not limited to personal computers, PDAs, PIMs, web-enabled telephones, and other appliances such as WebTV [TM] units. As such, we now turn our attention to disclosure of the present invention relative to the processes and methods preferably implemented as software and firmware on such a computing platform. It will be readily recognized by those skilled in the art that the methods and systems described herein may be alternatively realized as hardware functions, in part or in whole, without departing from the spirit and scope of the invention.

In conclusion, the present invention has been described in detail using certain generic embodiment options, and in terms of specific embodiment examples. It will be recognized by those skilled in the art, however, that these examples do not represent the scope and limits of the present invention, because many variations in programming methodology, choice of platforms, integration to alternate tools, and use of alternate electronic formats are possible without departing from the spirit of the invention. Therefore, the scope of the invention should be determined by the following claims.

What is claimed is:

1. A method for providing a performance-annotated, choreographer architecture related design depiction of a computer-executable application program, said method comprising the steps of:
receiving from a choreographer architecture design tool an electronic workflow depiction of an application program having a plurality of program methods and program objects, and a list of said program methods and program objects;
receiving from a performance monitoring system a set of performance data regarding execution of said application program, program methods and program objects;
for each of said program methods and program objects, modifying said workflow depiction to indicate at least one factor extracted from said performance data to indicate said factor visually in said workflow depiction; and
rendering said workflow depiction annotated with said performance factor for viewing by a human user.

2. The method as set forth in claim 1 wherein said step of receiving a workflow depiction comprises receiving extensible markup language.

3. The method as set forth in claim 1 wherein said step of rendering a performance-factor annotated workflow diagram generator comprises rendering extensible markup language.

4. The method as set forth in claim 1 wherein said step of rendering a performance-factor annotated workflow diagram generator comprises a step selected from the group of displaying on a computer display, printing a document, and transmitting an electronic diagram.

5. The method as set forth in claim 1 wherein said step of modifying said workflow depiction to indicate at least one factor extracted from said performance data to indicate said factor visually in said workflow depiction comprises annotating a factor selected from the group of a time value indicating when the method was called, a time value indicating when the method was completed, a time value indicating the duration of executing of the method, an indication of how many times a method was called, an indication of which methods have not been executed at least one time, an indication of the execution status of the method.

6. A computer readable medium encoded with software for providing a performance-annotated, choreographer architecture related design depiction of a computer-executable application program, said software performing the steps of:
receiving from a choreographer architecture design tool an electronic workflow depiction of an application program having a plurality of program methods and program objects, and a list of said program methods and program objects;
receiving from a performance monitoring system a set of performance data regarding execution of said application program, program methods and program objects;
for each of said program methods and program objects, modifying said workflow depiction to indicate at least one factor extracted from said performance data to indicate said factor visually in said workflow depiction; and
rendering said workflow depiction annotated with said performance factor for viewing by a human user.

7. The computer readable medium as set forth in claim 6 wherein said software for receiving a workflow depiction comprises software for receiving extensible markup language.

8. The computer readable medium as set forth in claim 6 wherein said software for rendering a performance-factor annotated workflow diagram generator comprises software for rendering extensible markup language.

9. The computer readable medium as set forth in claim 6 wherein said software for rendering a performance-factor annotated workflow diagram generator comprises software for performing an action selected from the group of displaying on a computer display, printing a document, and transmitting an electronic diagram.

10. The computer readable medium as set forth in claim 6 wherein said software for modifying said workflow depiction to indicate at least one factor extracted from said performance data to indicate said factor visually in said workflow depiction comprises software for annotating a factor selected from the group of a time value indicating when the method was called, a time value indicating when the method was completed, a time value indicating the duration of executing of the method, an indication of how many times a method was called, an indication of which methods have not been executed at least one time, an indication of the execution status of the method.

11. A system for providing a performance-annotated, choreographer architecture related design depiction of a computer-executable application program, said system comprising:
an electronic workflow depiction of an application program having a plurality of program methods and program objects, and a list of said program methods and program objects, both of which being received from a choreographer architecture design tool;
a set of performance data regarding execution of said application program, program methods and program objects, said performance data being received from a performance monitoring system;
a diagram generator adapted to, for each of said program methods and program objects, modify said workflow depiction to indicate at least one factor extracted from said performance data to indicate said factor visually in said workflow depiction; and
a user output adapted to render said workflow depiction annotated with said performance factor for viewing by a human user.

12. The system as set forth in claim 11 wherein said received workflow depiction comprises a diagram encoded in extensible markup language.

13. The system as set forth in claim 11 wherein said diagram generator is adapted to generate an annotated workflow depiction encoded in extensible markup language.

14. The system as set forth in claim 11 wherein said user output comprises a device selected from the group of a computer display, a document printer, and an electronic diagram transmitter.

15. The system as set forth in claim 111 wherein said diagram generator is further configured to annotate a factor selected from the group of a time value indicating when the method was called, a time value indicating when the method was completed, a time value indicating the duration of executing of the method, an indication of how many times a method was called, an indication of which methods have not been executed at least one time, an indication of the execution status of the method.
